(19) United States
(12) Patent Application Publication
(10) Pub. No.: US 2019/0052311 A1
(43) Pub. Date: Feb. 14, 2019

(54) FULL DUPLEX TRANSCEIVERS HAVING DIGITAL DISTORTION COMPENSATION AND METHODS OF THEREOF

(71) Applicant: Nokia Solutions and Networks OY, Espoo (FI)

(72) Inventors: Rosanah MURUGESU, Warren, NJ (US); Hungkei CHOW, Livingston, NJ (US); Werner COOMANS, Asse (BE)

(73) Assignee: Nokia Solutions and Networks OY, Espoo (FI)

(21) Appl. No.: 15/671,292

(22) Filed: Aug. 8, 2017

(51) Int. Cl. H04B 3/23; H04B 3/21; H04L 5/14; H04L 25/03

(52) U.S. Cl. CPC H04B 3/237; H04L 25/03006; H04L 5/1461; H04B 3/21

(57) ABSTRACT

In an example embodiment, a full duplex transceiver includes an analog-to-digital converter (ADC), at least one processor, a first digital-to-analog converter (DAC) and an amplifier. The ADC is configured to convert an analog first signal to a digital first signal, the analog first signal being based on a transmitted signal from the transceiver and a received signal from a far-end transceiver. The at least one processor is configured to determine pre-distortion compensation coefficients using the digital first signal and a first input signal and generate a pre-distorted compensated input signal based on the pre-distortion compensation coefficients. The first DAC is configured to convert the pre-distortion compensated input signal to an analog input signal. The amplifier is configured to amplify the analog input signal to a subsequent transmit signal.

### BACKGROUND

In wireless and wireline communication systems, a power amplifier (PA) is often included in a transmitter to amplify an output signal.

To improve power efficiency, the PA often operates near its saturation region. At the saturation region, most PA's exhibit nonlinear characteristics. PA nonlinearity also gives rise to several forms of distortion, such as harmonic distortion, spectral regrowth and intermodulation distortion. Combining with typical high peak-to-average-power modulation schemes (like Orthogonal Frequency Division Multiplexing), nonlinear distortion is a factor in the overall system design of wireless and wireline communication systems.

Furthermore, these distortions are even more harmful in full-duplex (FDX) transmission. Transmitter distortion couples directly into a receiver. This coupling affects the performance of the receiver. More specifically, nonlinear distortion affects performance of an echo canceler in the FDX transmission system.

FIG. 1 illustrates a conventional transceiver having closed-loop digital pre-distortion compensation. Adaptive digital pre-distortion (DPD) technique is a method to compensate for nonlinear distortion. In adaptive DPD, a digital pre-distorter 105 changes a modulated signal x(k) to counter the nonlinear effect and generates a pre-distorted transmit signal x_{DPD}(k). The pre-distorted transmit signal x_{DPD}(k) is converted into an analog signal x_{DPD}(t) using a digital-to-analog converter (DAC) 110. The analog signal x_{DPD}(t) is input to an IQ mixer 115 that receives an output from a local oscillator (LO). The resulting analog signal x_{RF}(t) is then amplified by a PA 120. The PA 120 output is sampled, subjected to an IQ mixer 122 that also receives the output from the LO and converted into a digital format using an analog-to-digital converter (ADC) 125. A converted signal y(k) output by the ADC 125 is used as a reference signal. A DPD estimator 130 compares the original transmit digital signal x(k) with the digital reference signal y(k) in order to adapt the pre-distorter 105 to compensate for the nonlinearities introduced by the output of the PA 120.

### SUMMARY

A drawback of the conventional transceiver illustrated in FIG. 1 is the additional ADC 125 is used to obtain the reference signal y(k). An alternative solution is to use the ADC of the receiver of that same transceiver. An analog switch can be used to periodically redirect the transmit signal to the receiver. However, when the transmit signal is switched to the receiving circuit, both transmission and reception are interrupted.

In an example embodiment, a full duplex transceiver includes an analog-to-digital converter (ADC), at least one processor, a first digital-to-analog converter (DAC) and an amplifier. The ADC is configured to convert an analog first signal to a digital first signal, the analog first signal being based on a transmitted signal from the transceiver and a received signal from a far-end transceiver. The at least one processor is configured to determine pre-distortion compensation coefficients using the digital first signal and a first input signal and generate a pre-distorted compensated input signal based on the pre-distortion compensation coefficients. The first DAC is configured to convert the pre-distortion compensated input signal to an analog input signal. The amplifier is configured to amplify the analog input signal to a subsequent transmit signal.

In an example embodiment, the at least one processor is configured to determine an echo cancellation signal, the digital first signal being further based on the echo cancellation signal.

In an example embodiment, the at least one processor is configured to determine the pre-distortion compensation coefficients based on a correlation between the first input signal and the digital first signal.

In an example embodiment, the at least one processor is configured to determine the pre-distortion compensation coefficients during a transceiver operation using a gradient descent algorithm.

In an example embodiment, the at least one processor is configured to determine the pre-distortion compensation coefficients during an initial estimation using a least mean square algorithm.

In an example embodiment, the at least one processor is configured to determine post-distortion compensation coefficients using the digital first signal and the first input signal.

In an example embodiment, the at least one processor is configured to determine the post-distortion compensation coefficients after determining the pre-distortion compensation coefficients.

In an example embodiment, the at least one processor is configured to generate the pre-distortion compensated input signal by generating polynomials of a second input signal and filtering the polynomials using the pre-distortion compensation coefficients.

In an example embodiment, the polynomials are odd numbered polynomials.

At least one example embodiment provides a method including converting an analog first signal to a digital first signal, the analog first signal being based on a transmitted signal from a full duplex transceiver and a received signal from a far-end transmitter, determining pre-distortion compensation coefficients using the digital first signal and a first input signal, generating a pre-distortion compensated input signal based on the pre-distortion compensation coefficients, converting the pre-distortion compensated input signal to an analog input signal and amplifying the analog input signal to a subsequent transmit signal.

In an example embodiment, the method further includes performing full duplex transmission of the subsequent transmit signal.

In an example embodiment, the method further includes determining an echo cancellation signal, the digital first signal being further based on the echo cancellation signal.

In an example embodiment, the determining determines the pre-distortion compensation coefficients based on a correlation between the first input signal and the digital first signal.

In an example embodiment, the method determines the pre-distortion compensation coefficients during a tracking and update phase using a gradient descent algorithm.

In an example embodiment, the determining determines the pre-distortion compensation coefficients during an initial estimation using a least mean square algorithm.

In an example embodiment, the method further includes determining post-distortion compensation coefficients using the digital first signal and the first input signal.

In an example embodiment, the determining the post-distortion compensation coefficients determines the post-distortion compensation coefficients after determining the pre-distortion compensation coefficients.

In an example embodiment, the generating generates the pre-distortion compensated input signal by generating polynomials of a second input signal and filtering the polynomials using the pre-distortion compensation coefficients.

In an example embodiment, the polynomials are odd numbered polynomials.

### BRIEF DESCRIPTION OF THE DRAWINGS

Example embodiments will be more clearly understood from the following detailed description taken in conjunction with the accompanying drawings. FIGS. 1-8 represent non-limiting, example embodiments as described herein.

FIG. 1 illustrates a conventional transceiver having closed-loop digital pre-distortion compensation;

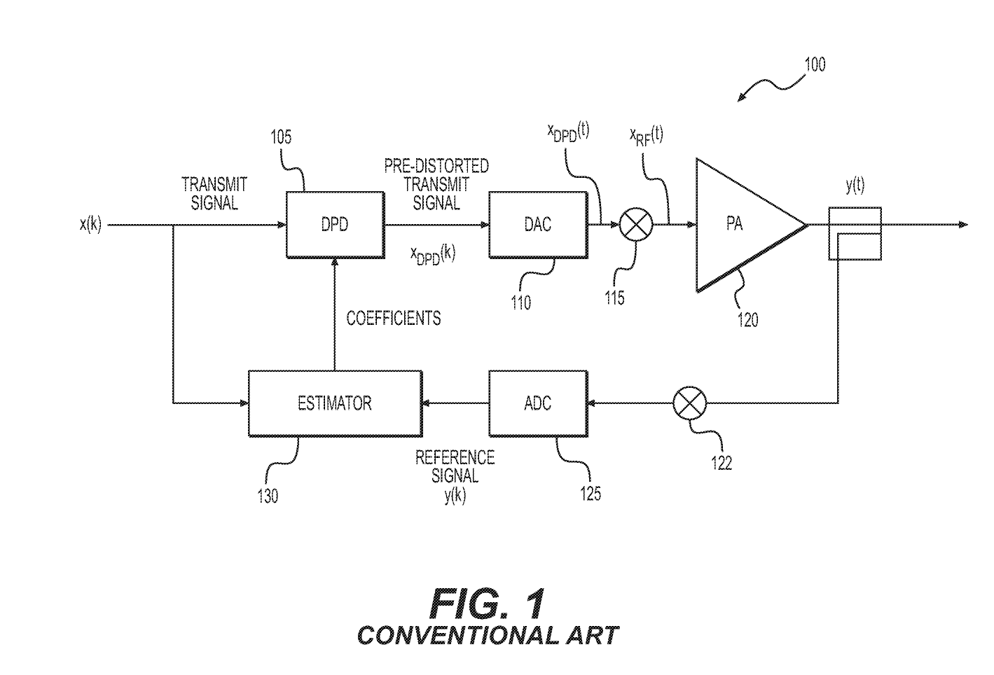

FIG. 2 illustrates a transceiver having digital pre-distortion compensation according to an example embodiment;

FIG. 3 illustrates an example embodiment of a digital pre-distortion compensation filter shown in FIG. 2;

FIG. 4 illustrates a transceiver having digital post-distortion compensation according to an example embodiment;

FIG. 5 illustrates an example embodiment of a digital post-distortion compensation filter shown in FIG. 4;

FIG. 6 illustrates a transceiver having digital post-distortion and pre-distortion compensation according to an example embodiment;

FIG. 7 illustrates a method of performing digital pre-distortion compensation according to an example embodiment; and

FIG. 8 illustrates a communication system according to an example embodiment.

### DETAILED DESCRIPTION

Various example embodiments will now be described more fully with reference to the accompanying drawings in which some example embodiments are illustrated.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the claims. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of example embodiments and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the following description, illustrative embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware at existing network elements or control nodes. Such existing hardware may include one or more Central Processing Units (CPUs), digital signal processors (DSPs), application-specific-integrated-circuits, field programmable gate arrays (FPGAs) computers, system-on-chip (SoC) or the like.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of example embodiments are typically encoded on some form of tangible (or recording) storage medium. The tangible storage medium may be magnetic (e.g., a floppy disk or a hard drive), optical (e.g., a compact disk read only memory, or “CD ROM”), and may be read-only memory (ROM), random access memory (RAM), flash memory (e.g., USB flash drives, memory cards, memory sticks, etc.), for example. The terms “tangible storage medium” and “memory” may be used interchangeably. Example embodiments are not limited by these aspects of any given implementation.

As stated above, power amplifiers in wireless and wireline communication systems operate near a saturation region. In the saturation region, the power amplifier exhibits nonlinear characteristics. In FDX transmission systems, nonlinear distortion affects a performance of an echo canceler. Closed-loop DPD is one method used to compensate for nonlinear distortion. Conventional closed-loop DPD systems use an additional ADC in the transmit processing path to obtain a reference signal. If instead, the ADC used for DPD training is also the receiver ADC of the transceiver, an analog switch is typically used to periodically redirect the transmit signal to the receiver. When the transmit signal is switched to the receiving circuit, both transmission and reception will have to be interrupted.

At least some example embodiments use the ADC of the receive processing path in a FDX transmission system to track distortion compensation coefficients. Moreover, at least some example embodiments use an echo cancellation (EC) function, which is already present in the FDX system, to improve ADC scaling such that a signal-to-noise and distortion ratio (SNDR) requirement of the receiving ADC can be relaxed. At least some example embodiments present a method to track and update distortion compensation coefficients while the system is operating normally. Therefore, no service interruption is incurred during tracking and update. The presented method exploits the fact that the receive signal is uncorrelated with the transmit signal.

In addition, at least some example embodiments accommodate a post-distortion compensation function, which can work standalone or alongside with the DPD technique, to further improve the overall system performance. Similar to DPD, post-distortion compensation according to example embodiments requires no additional ADC and benefits from EC function in the FDX transmission.

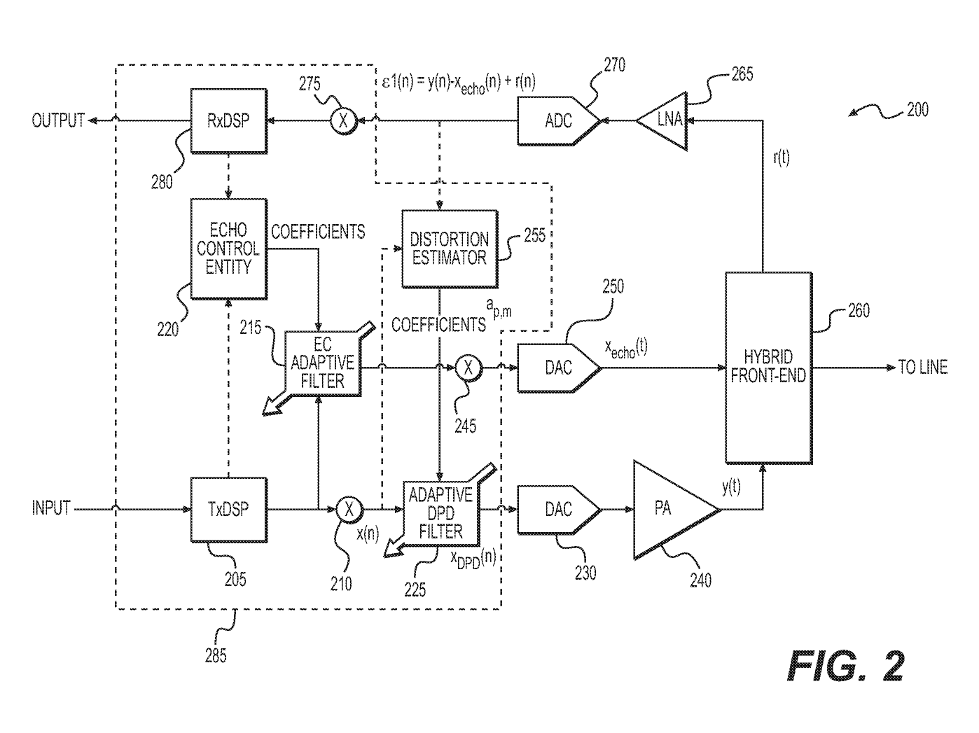

FIG. 2 illustrates a transceiver having digital pre-distortion compensation according to an example embodiment.

As shown, a transceiver 200 may be a full-duplex DOCSIS cable modem termination system (CMTS) or Remote-PHY device (RPD). The transceiver includes a transmission path digital signal processor (TxDSP) 205, a first digital up-converter 210, an echo cancellation (EC) adaptive filter 215, an echo control entity 220, an adaptive DPD filter 225, a first DAC 230, a PA 240, a second digital up-converter 245, a second DAC 250, a distortion estimator 255, a hybrid front-end 260, a low-noise amplifier (LNA) 265, an ADC 270, a digital down-converter 275 and a receiving path digital signal processor (RxDSP) 280.

A processing system 285 includes the TxDSP 205, the first digital up-converter 210, the EC adaptive filter 215, the echo control entity 220, the adaptive DPD filter 225, the distortion estimator 255, the third digital down-converter 275 and the RxDSP 280.

The processing system 285 may be implemented in hardware, a processor configured to execute software, firmware, or any combination thereof, for example. When the processing system 285 is hardware, such existing hardware may include one or more Central Processing Units (CPUs), digital signal processors (DSPs), application-specific-integrated-circuits (ASICs), field programmable gate arrays (FPGAs) computers or the like configured as special purpose machines to perform the functions of the TxDSP 205, the first digital up-converter 210, the EC adaptive filter 215, the echo control entity 220, the adaptive DPD filter 225, the distortion estimator 255, the digital down-converter 275 and the RxDSP 280. CPUs, DSPs, ASICs and FPGAs may generally be referred to as processing devices.

In the event where the processing system 285 is a processor executing software, the processor is configured as a special purpose machine to execute the software, stored in a storage medium (e.g., a memory 825 or a memory 865), to perform the functions of the TxDSP 205, the first digital up-converter 210, the EC adaptive filter 215, the echo control entity 220, the adaptive DPD filter 225, the distortion estimator 255, the digital down-converter 275 and the RxDSP 280. In such an embodiment, the processor may include one or more Central Processing Units (CPUs), digital signal processors (DSPs), application-specific-integrated-circuits (ASICs), field programmable gate arrays (FPGAs) computers.

A transmit processing path may include the TxDSP 205, the first digital up-converter 210, the adaptive DPD filter 225, the distortion estimator 255, the first DAC 230, the PA 240 and the hybrid front-end 260

The TxDSP 205, which may be implemented in hardware or a processor executing software, implements a single channel or multiple channels transmitter function. For example, the TxDSP 205 may implement an orthogonal frequency-division multiplexing (OFDM) modulator that generates one or multiple channels of transmitting baseband signal.

The first digital up-converter 210 converts the output of the TxDSP 205 to generate a multi-channel wideband first input signal x(n). The adaptive DPD filter 225 filters the first input signal x(n) based on pre-distortion compensation coefficients a_{p,m} from the distortion estimator 255 and generates a pre-distortion compensated input signal x_{DPD}(n). The first DAC 230 converts the pre-distortion compensated input signal to an analog input signal. The analog input signal is amplified by the PA 240 to a transmit signal y(t). The transmit signal y(t) is transmitted by the hybrid front-end 260.

The hybrid front-end 260 is a 4-to-2 wire hybrid circuit that couples the transmitter and the receiver (4 wires) to the external line port (2 wires). The hybrid front-end 260 performs an initial directional separation between the transmitter and the receiver signals, while coupling the received far-end signal from the external line port to the receive processing path.

The operation of the distortion estimator 255 and the adaptive DPD filter 225 will be described in further detail.

In addition to the first DAC 230 in the transmit processing path, the transceiver 200 includes the second DAC 250 to generate an analog echo cancellation (EC) signal x_{echo}(t). The EC adaptive filter 215 creates a digital EC signal based on the output from the TxDSP 205 and the echo cancellation coefficients, which are estimated by the Echo Control Entity (ECE) 220. The EC signal x_{echo}(t) removes a self-interference signal coming from the transmit processing path, so that a resulting signal at a receive processing path is the signal transmitted from a far-end modem transceiver.

The receive processing path of the transceiver 200 includes the hybrid front-end 260, the LNA 265, the ADC 270, the digital down-converter 275 and the RxDSP 280

The LNA 265 receives a signal r(t) from a far-end transceiver and amplifies the signal r(t). The ADC 270 converts the signal r(t) from analog to digital.

The RxDSP 280, which may be hardware or a processor executing software, implements a single channel or multiple channels receiver function. For example, the RxDSP 280 may implement an orthogonal frequency-division multiple access (OFDMA) receiver function that demodulates one or multiple channels of baseband signal.

The TxDSP 205, the first digital up-converter 210, the EC adaptive filter 215, the ECE 220, the first DAC 230, the PA 240, the second digital up-converter 245, the second DAC 250, the hybrid front-end 260, the LNA 265, the ADC 270, the digital down-converter 275 and the RxDSP 280 are all known.

As shown in FIG. 2, the transceiver 200 uses the ADC 270 from the receive processing path to obtain a reference signal ε1(n) instead of employing a dedicated ADC to obtain a reference signal.

Using the ADC 270 from the receive processing path to obtain a reference signal saves costs and resolves at least two major drawbacks in the conventional DPD solution. First, to obtain an accurate enough reference signal, the dedicated ADC requires a higher sampling rate and precision than the transmit signal. A general rule of thumb is that its Signal to Noise and Distortion Ratio (SNDR) should be at least 10 dB better than the target SNDR. Otherwise, any distortion that falls below the noise floor of such ADC or distortion that is masked by the ADC incurred noise cannot be corrected. Therefore, the conventional approach requires a rather expensive ADC to obtain the reference output signal.

The transceiver 200 takes advantage of the echo cancellation function in the FDX system to measure the distortion with a better resolution. Since the PA output y(t) is cancelled by the echo cancellation signal x_{echo}(t), the ADC 270 at the receive processing path will be better scaled to measure the distortion produced by the PA 240 than the conventional dedicated ADC.

Secondly, as the ADC 270 at the receive processing path is used, a coefficient tracking and update procedure can be conducted while the PA 240 is operating normally. This prevents the system from going into an offline state that causes an undesirable service interruption.

The new solution exploits that the receive signal r(t) is not correlated with the transmit signal y(t).

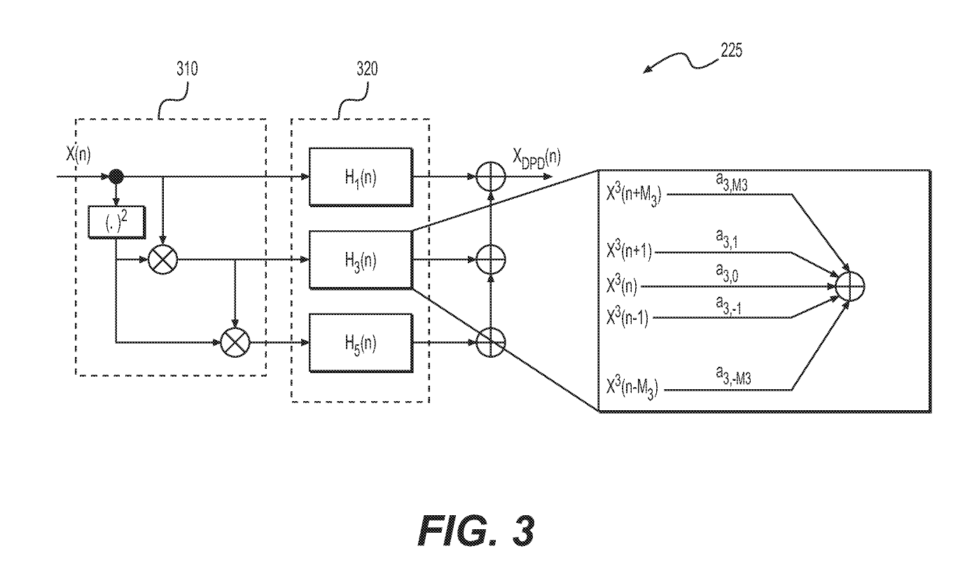

FIG. 3 illustrates an example embodiment of the adaptive DPD filter 225. The adaptive DPD filter 225 is a memory polynomial and includes a polynomial stage 310 and a filter stage 320. The polynomial stage 310 generates polynomials of the input signal x(n). The filter stage 320 includes a plurality of subfilters H₁(n), H₃(n) and H₅(n) for the polynomials, respectively. While only three polynomials are illustrated it should be understood that there may be more or less.

As shown in FIG. 3, the adaptive DPD filter 225 generates the pre-distortion compensated input signal as follows:

x_{DPD}(n)=Σₚ₌₁^{P}Σ_{m=-Mp}^{Mp}a_{p,m}·x(n−m)^{p} (1)

where P is the number of polynomial orders, Mₚ is the memory order per polynomial order and a_{p,m} is the pre-distortion compensation coefficient for the polynomial order p and the memory order m.

The number of polynomial orders P and the memory order per polynomial order Mₚ depends on the line driver and operation point. A more nonlinear line driver operating closer to the saturation point increases the polynomial order P of the DPD model used for correction. A line driver which has long memory (such as those with harmonic tuning) increases the memory order Mp of the DPD model used for correction.

As shown in FIG. 3, odd polynomials of x(n) are used to generate the pre-distortion compensated input signal x_{DPD}(n).

The distortion estimator 255 determines the pre-distortion coefficients a_{p,m} during an initial calibration and continuous tracking.

During the initial calibration, only one transceiver port is transmitting from the hybrid front-end 260 and the pre-distortion coefficients a_{init,p,m} are all 0 except for a_{init,1,0}=1 such that far-end transmitters are silenced.

The pre-distortion coefficients a_{p,m} are then solved by the distortion estimator 255 using a least squares algorithm as follows:

ϵ1(n)=y(n)−x_{echo}(n)+r(n) (2)

where y(n) is a digital signal of the analog signal y(t) and r(n) is a digital signal of the analog signal r(t) (during initial calibration r(t)=0);
minimize: [symbol] − [symbol] · [symbol] |², where

[symbol]

=[ϵ1(n) . . . ϵ1(n−N)] (3)

[symbol]

=[Δa_{1,-M1} . . . Δa_{1,0} . . . Δa_{1,M1} . . . Δa_{P,MP}] (4)

Δa is the error in the compensation coefficients (difference between current coefficients and optimal coefficients);

$$\vec{Z} = [ \begin{matrix}{z}_{1 , - M 1} ( x ( n ) ) & ⋯ & {z}_{1 , - M 1} ( x ( n - N ) ) \\ ⋮ & ⋯ & ⋮ \\ {z}_{P , MP} ( x ( n ) ) & ⋯ & {z}_{P , MP} ( x ( n - N ) )\end{matrix} ] \qquad ( 5 )$$

where N is the number of captured input and output samples and:

z_{P,MP}(x(n))=x(n+M_{P})^{p} (6)

and

[symbol]

= [symbol] · [symbol] ^{T}·( [symbol] · [symbol] ^{T})⁻¹ (7)

is the least squares solution; and

[symbol]

_{new}= [symbol] ᵢₙᵢₜ− [symbol] (8)

where [symbol] _{new} is the updated pre-distortion compensation vector based on a previous pre-distortion vector [symbol] ᵢₙᵢₜ and an error vector [symbol] .

The distortion estimator 255 can then update the pre-distortion compensation coefficients a_{p,m} using a gradient descent or least mean square algorithm. The distortion estimator 255 may update the pre-distortion compensation coefficients a_{p,m} periodically (e.g., once every minute), dynamically or when a threshold condition is met.

Using a gradient descent algorithm, the distortion estimator 255 may update the pre-distortion compensation coefficients a_{p,m} as follows:

$$\begin{matrix}{a}_{p , m} ( i + 1 ) = {a}_{p , m} ( i ) - μ \frac{{dE}^{2}}{{da}_{p , m}} & ( 9 ) \\ {a}_{p , m} ( i + 1 ) = {a}_{p , m} ( i ) - 2 μ E \frac{dE}{{da}_{p , m}} & ( 10 )\end{matrix}$$

where μ is the gradient step size, E as the correlation between the transmit signal x(n) and receive signal (after echo is removed) at the ADC 270, ϵ1(n); and ϵ1(n)=y(n)−x_{echo}(n)+r(n), where r(n) is the digital received signal (converted from the received analog signal r(t)) and ϵ1(n) is time aligned with the input signal x(n)). In an example embodiment, post-equalization may be performed on the signal measured by the ADC 270 to remove an effect of the channel.

If the instantaneous value of x(n)·ϵ1(n) is an estimate of correlation, i.e., E=x(n)·(ϵ1(n)), then

E=x(n)·(PA{x_{DPD}(n)}−x_{echo}(n)+r(n)), (11)

where PA{ } is the PA response.

The PA response is assumed to be of the form:

PA{x_{DPD}(n)}Σᵣ₌₁^{R}Σ_{l=-Lr}^{Lr}b_{r,l}·x_{DPD}(n−l)^{r}, (12)

where b_{r,l} is a coefficient of the response of the PA for a polynomial order r and a memory order per polynomial order Lᵣ.

By assuming the transmitted signal x(n) is correlated only with the residual echo y(n)−x_{echo}(n), but uncorrelated with the received signal r(n), then:

$$\frac{dE}{{da}_{p , m}} = x ( n ) \cdot {Σ}_{r = 1}^{R} {Σ}_{l = - Lr}^{Lr} {b}_{r , l} \cdot {{rx}_{DPD} ( n - l )}^{r - 1} \cdot \frac{{dx}_{PDP} ( n - l )}{{da}_{p , m}} \qquad ( 13 )$$

Assuming the coefficient b_{1,0} is much larger than the other coefficients (the PA is already quite linear with starting SNR of >35 dB), then

$$\begin{matrix}\frac{dE}{{da}_{p , m}} \approx x ( n ) \cdot ( {b}_{1 , 0} ) \cdot \frac{{dx}_{DPD} ( n )}{{da}_{p , m}} & ( 14 ) \\ \frac{dE}{{da}_{p , m}} \approx x ( n ) \cdot ( {b}_{1 , 0} ) \cdot {x ( n - m )}^{p} & ( 15 )\end{matrix}$$

Therefore, the distortion estimator 255 updates the pre-distortion compensation coefficients a_{p,m} as follows:

a_{p,m}(i+1)=a_{p,m}(i)−2μ·x(n)·ϵ1(n)·x(n)·x(n−m)ₚ (16)

Furthermore, x(n−m)^{p} values can be calculated by the distortion estimator 255 and updated in blocks of data. Therefore, the coefficient tracking and update procedure can further be simplified as:

a_{p,m}(i+1)=a_{p,m}(i)−2μ·avg{x(n)·ϵ1(n)·x(n)·x(n−m)ₚ} (17)

If the coefficient b_{1,0}>>b_{i,j} is not true, the distortion estimator 255 may use a least mean square algorithm to determine the pre-distortion compensation coefficients a_{p,m}. The least mean square algorithm used for updating may be the same as the least mean square algorithm for initial calibration except the sample size N is smaller and

[symbol]

= [symbol] −μ [symbol] (18)

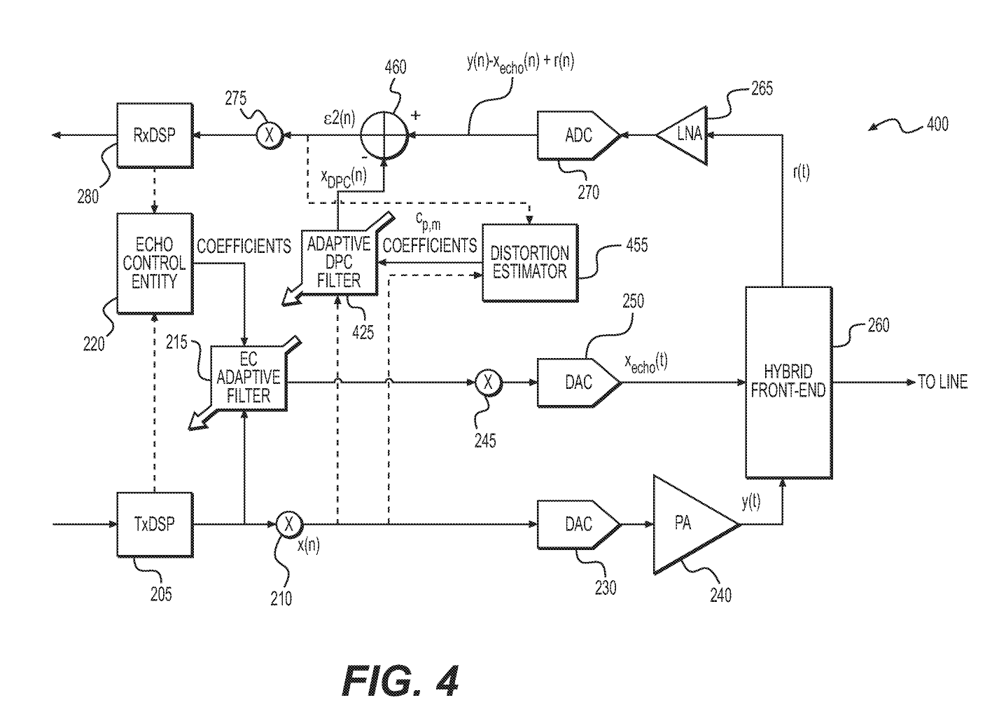

FIG. 4 illustrates a transceiver having digital post-distortion compensation according to an example embodiment.

As shown in FIG. 4, a transceiver 400 is similar to the transceiver 200. Thus, only the differences will be described.

The transceiver 400 is configured to perform digital post-distortion compensation (DPC) as opposed to DPD.

In FIG. 4, the output of the ADC 270, y(n) is reduced by a post-distortion compensation signal x_{DPC}(n) at a subtractor 460. A distortion estimator 455 receives an output of the subtractor 460 and determines post-distortion compensation coefficients c_{p,m} based on the input signal x(n) and the output of the subtractor 460.

The distortion estimator 455 determines the post-distortion compensation coefficients c_{p,m} during an initial calibration and on-going tracking.

During the initial calibration, only one transceiver is transmitting from the hybrid front-end 260 and the post-distortion compensation coefficients c_{p,m} are all 0 such that far-end transmitters are silenced (i.e., r(t)=0).

The post-distortion compensation coefficients c_{p,m} are then solved by the distortion estimator 455 using a least squares algorithm as follows:

[symbol]

= [symbol] · [symbol] (19)

minimize: [symbol] − [symbol] · [symbol] |², where

$$\begin{matrix}= [ ɛ2 ( n ) …ɛ2 ( n - N ) ] & ( 20 ) \\ \vec{c} = [ {c}_{1 , - M 1} … {c}_{1 , 0} … {c}_{1 , M 1} … {c}_{P , MP} ] & ( 21 ) \\ \vec{Z} = [ \begin{matrix}{z}_{1 , - M 1} ( x ( n ) ) & ⋯ & {z}_{1 , - M 1} ( x ( n - N ) ) \\ ⋮ & ⋯ & ⋮ \\ {z}_{P , MP} ( x ( n ) ) & ⋯ & {z}_{P , MP} ( x ( n - N ) )\end{matrix} ] & ( 22 )\end{matrix}$$

where N is the number of captured input and output samples and:

z_{P,MP}(x(n))=x(n+M_{P})^{p} (23)

and

[symbol]

= [symbol] · [symbol] ^{T}·( [symbol] · [symbol] ^{T})⁻¹ (24)

is the least squares solution.

The distortion estimator 455 can then update the post-distortion compensation coefficients c_{p,m} using a gradient descent or least mean square algorithm. The distortion estimator 455 may update the pre-distortion compensation coefficients c_{p,m} periodically (e.g., once every minute), dynamically or when a threshold condition is met.

Using a gradient descent algorithm, the distortion estimator 455 may update the post-distortion compensation coefficients c_{p,m} as follows:

$$\begin{matrix}{c}_{p , m} ( i + 1 ) = {c}_{p , m} ( i ) - μ \frac{{dE}^{2}}{{dc}_{p , m}} & ( 25 ) \\ {c}_{p , m} ( i + 1 ) = {c}_{p , m} ( i ) - 2 μ E \frac{dE}{{dc}_{p , m}} & ( 26 )\end{matrix}$$

As discussed above, E is an error criterion that is driven to zero and is a correlation between the input signal x(n) and the signal received in the ADC 270 (after echo is removed). Thus,

E=x(n)·ϵ2(n) (27)

where

ϵ2(n)=y(n)−x_{echo}(n)+r(n)−x_{DPC}(n), (28)

where x_{DPC}(n) is the post-distortion compensation signal.

If x(n)·ϵ2(n) is an estimate of correlation, then

E=x(n)·(y(n)−x_{echo}(n)+r(n)−x_{DPC}(n)); (29)

E=x(n)·(y(n)−x_{echo}(n)+r(n)−Σₚ₌₁^{P}Σm=−Mp^{Mp}c_{p,m}·x(n−m)^{p}), (30)

where the post-distortion compensation signal x_{DPC}(n) can be modeled as:

$$\begin{matrix}{Σ}_{p = 1}^{p} {Σ}_{m = - Mp}^{Mp} {c}_{p , m} \cdot {x ( n - m )}^{p} ; and & ( 31 ) \\ \frac{dE}{{dc}_{p , m}} = - x ( n ) \cdot {x ( n - m )}^{p} . & ( 32 )\end{matrix}$$

Therefore, the distortion estimator 455 may update the post-distortion compensation coefficients c_{p,m} as follows:

c_{p,m}(i+1)=c_{p,m}(i)+2μ·x(n)·ϵ2(n)·x(n)·x(n−m)^{p} (33)

The x(n−m)^{p} values can be calculated by the distortion estimator 455 in blocks of data, which simplifies the algorithm into:

c_{p,m}(i+1)=c_{p,m}(i)−2μ·avg{x(n)·ϵ2(n)·x(n)·x(n−m)^{p}} (34)

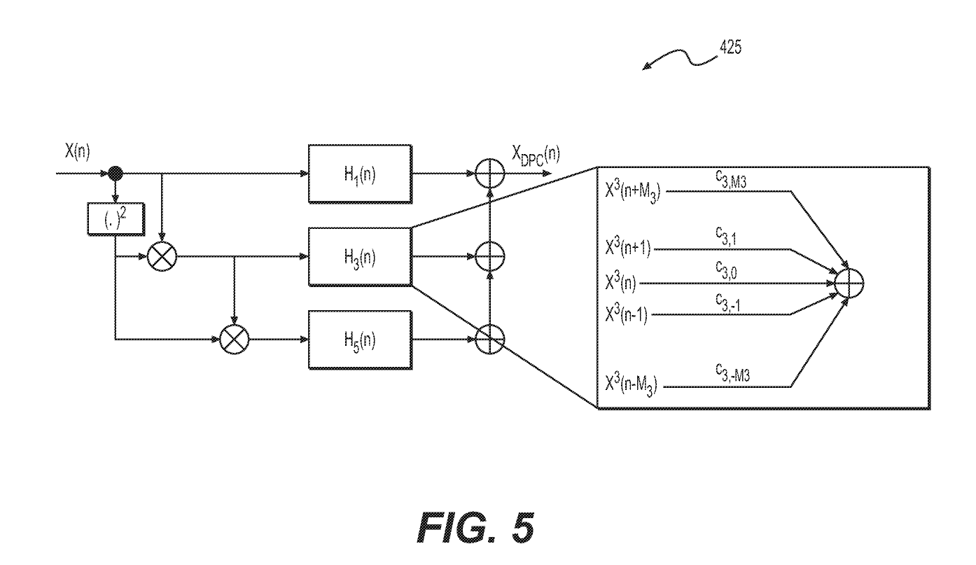

An adaptive DPC filter 425 generates the post-distortion compensated input signal x_{DPC}(n) using the post-distortion compensation coefficients c_{p,m}. As shown in FIG. 5, the adaptive DPC filter 425 generates the post-distortion compensated input signal x_{DPC}(n) in a similar manner as the adaptive DPD filter 225 generates the pre-distortion compensated input signal x_{DPD}(n). For example, the adaptive DPC filter 425 generates the post-distortion compensated input signal x_{DPC}(n) using the following equation:

x_{DPC}(n)=Σₚ₌₁^{P}Σm=−Mp^{Mp}c_{p,m}·x(n−m)^{p} (35)

It should be noted that, in other example embodiments, the memory depth and polynomial order implemented by the adaptive DPC filter 425 and the adaptive DPD filter 225 may be different.

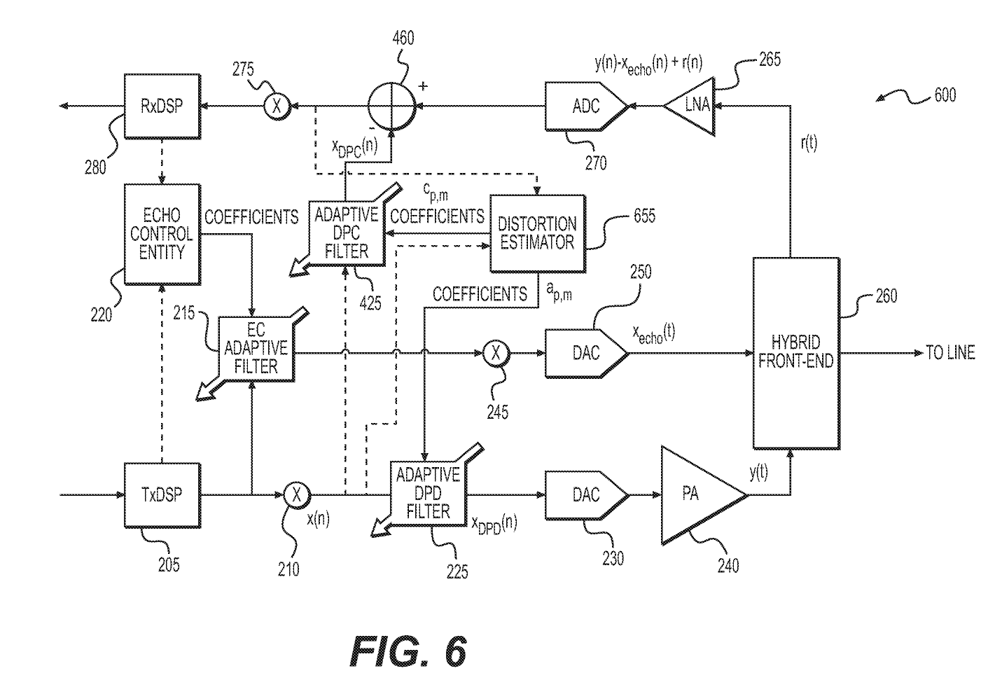

FIG. 6 illustrates a transceiver having digital post-distortion and pre-distortion compensation according to an example embodiment.

As shown in FIG. 6, a transceiver 600 is similar to the transceiver 200 and the transceiver 400. Thus, only the differences will be described.

In FIG. 6, a distortion estimator 655 performs the functions of the distortion estimator 255 (in FIG. 2) as well as the distortion estimator 455 (in FIG. 4). More specifically, the distortion estimator 655 performs pre-distortion estimation first, as described with reference to the distortion estimator 255, and then performs post-distortion estimation, as described with reference to the distortion estimator 455. The pre-distortion and post-distortion estimation operations performed by the distortion estimator 655 operate independently and update coefficients separately.

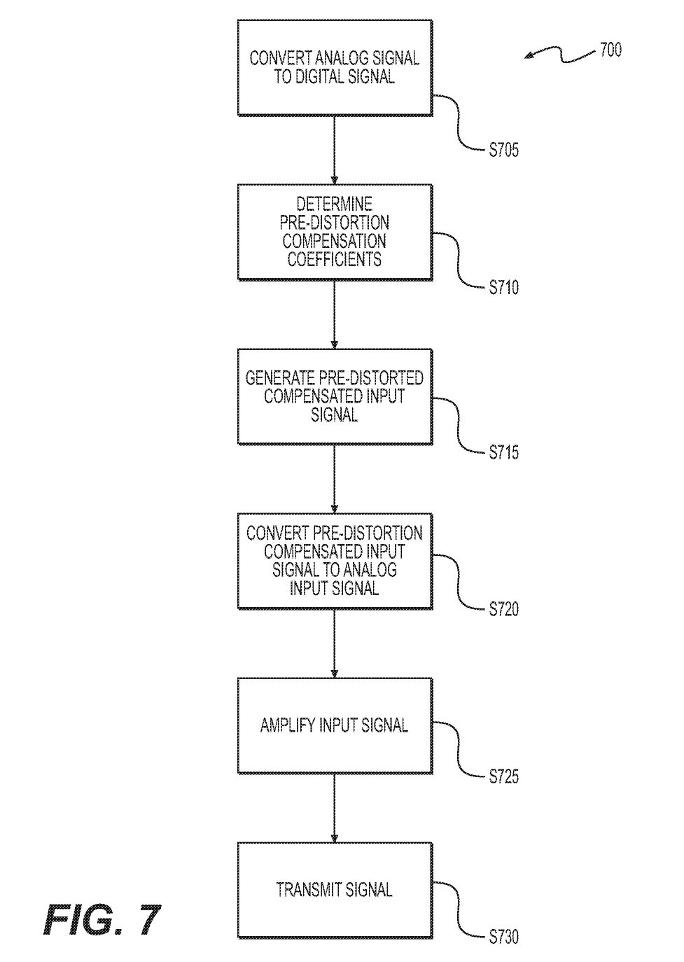

FIG. 7 illustrates a method of performing digital pre-distortion compensation according to an example embodiment. The method of FIG. 7 may be performed by the transceiver 200, for example.

At S705, an ADC converts an analog signal into a digital signal. The analog signal is based on both a transmitted signal from a transceiver and a received signal from a far-end transmitter. For example, the ADC 270 converts the received signal r(t) into the signal r(n) and a reference signal a reference signal ϵ1(n) is obtained.

As S710, the processing system 285 determines pre-distortion compensation coefficients using the digital signal and an input signal. For example, the distortion estimator 255 determines the pre-distortion coefficients a_{p,m} based on the signals x(n) and r(n).

At S715, the processing system generates a pre-distorted compensated input signal based on the pre-distortion compensation coefficients. For example, the adaptive DPD filter 225 generates the pre-distortion compensated input signal x_{DPD}(n) using the pre-distortion coefficients a_{p,m}.

At S720, the processing system converts the pre-distortion compensated input signal to an analog input signal. For example, the first DAC 230 converts the pre-distortion compensated input signal x_{DPD}(n) into an analog input signal.

At S725, the processing system amplifies the analog input signal. For example, the PA 240 amplifies the analog input signal to generate a transmit signal y(t). At S730, the transceiver 200 transmits the transmit signal y(t).

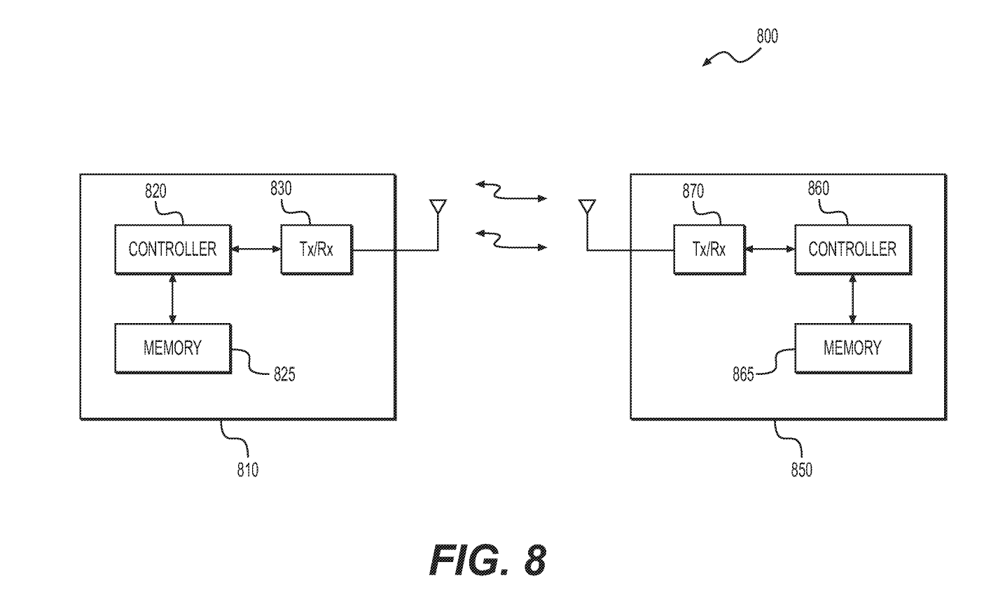

FIG. 8 illustrates a communication system according to an example embodiment.

As shown in FIG. 8, a system 800 includes two nodes 810 and 850 configured to communicate with each other wirelessly or using wired technologies.

The node 810 includes a transceiver 830 and a controller 820. The node 850 includes a transceiver 870 and a controller 860. The controllers 820 and 860 are configured to perform the algorithms described above with reference to FIGS. 2-6. For example, the controller 860 may be the processing system 285. In an example embodiment, each of the controllers 820 and 860 is at least one processor that performs the algorithms described with reference to FIGS. 2-6 by executing computer readable instructions stored in the memory 825 and the memory 865, respectively.

As described above, example embodiments do not require a dedicated high performance ADC with relatively high SNDR and sampling rate to obtain the reference signal. Instead, example embodiments use the existing ADC at the receive processing path to track distortion compensation coefficients, resulting in savings in cost and overall system power consumption.

Example embodiments being thus described, it will be obvious that the same may be varied in many ways. Such variations are not to be regarded as a departure from the spirit and scope of example embodiments, and all such modifications as would be obvious to one skilled in the art are intended to be included within the scope of the claims.

1. A full duplex transceiver comprising:
an analog-to-digital converter (ADC) configured to convert an analog first signal to a digital first signal, the analog first signal being based on a transmitted signal from the full duplex transceiver and a received signal from a far-end transmitter;
at least one processor configured to,
determine pre-distortion compensation coefficients using the digital first signal and a first input signal, and
generate a pre-distortion compensated input signal based on the pre-distortion compensation coefficients;
a first digital-to-analog converter (DAC) configured to convert the pre-distortion compensated input signal to an analog input signal; and
an amplifier configured to amplify the analog input signal to a subsequent transmit signal.

2. The full duplex transceiver of claim 1, wherein the at least one processor is configured to determine an echo cancellation signal, the digital first signal being further based on the echo cancellation signal.

3. The full duplex transceiver of claim 2, wherein the at least one processor is configured to determine the pre-distortion compensation coefficients based on a correlation between the first input signal and the digital first signal.

4. The full duplex transceiver of claim 2, wherein the at least one processor is configured to determine the pre-distortion compensation coefficients during a tracking and update phase using a gradient descent algorithm.

5. The full duplex transceiver of claim 2, wherein the at least one processor is configured to determine the pre-distortion compensation coefficients during an initial estimation using a least mean square algorithm.

6. The full duplex transceiver of claim 1, wherein the at least one processor is configured to determine post-distortion compensation coefficients using the digital first signal and the first input signal.

7. The full duplex transceiver of claim 6, wherein the at least one processor is configured to determine the post-distortion compensation coefficients after determining the pre-distortion compensation coefficients.

8. The full duplex transceiver of claim 1, wherein the at least one processor is configured to generate the pre-distortion compensated input signal by generating polynomials of a second input signal and filtering the polynomials using the pre-distortion compensation coefficients.

9. The full duplex transceiver of claim 8, wherein the polynomials are odd numbered polynomials.

10. A method comprising:
converting an analog first signal to a digital first signal, the analog first signal being based on a transmitted signal from a full duplex transceiver and a received signal from a far-end transmitter;
determining pre-distortion compensation coefficients using the digital first signal and a first input signal;
generating a pre-distortion compensated input signal based on the pre-distortion compensation coefficients;
converting the pre-distortion compensated input signal to an analog input signal; and
amplifying the analog input signal to a subsequent transmit signal.

11. The method of claim 10, further comprising:
performing full duplex transmission of the subsequent transmit signal.

12. The method of claim 11, further comprising:
determining an echo cancellation signal, the digital first signal being further based on the echo cancellation signal.

13. The method of claim 12, wherein the determining determines the pre-distortion compensation coefficients based on a correlation between the first input signal and the digital first signal.

14. The method of claim 12, wherein the determining determines the pre-distortion compensation coefficients during a tracking and update phase using a gradient descent algorithm.

15. The method of claim 12, wherein the determining determines the pre-distortion compensation coefficients during an initial estimation using a least mean square algorithm.

16. The method of claim 11, further comprising:
determining post-distortion compensation coefficients using the digital first signal and the first input signal.

17. The method of claim 16, wherein the determining the post-distortion compensation coefficients determines the post-distortion compensation coefficients after determining the pre-distortion compensation coefficients.

18. The method of claim 11, wherein the generating generates the pre-distortion compensated input signal by generating polynomials of a second input signal and filtering the polynomials using the pre-distortion compensation coefficients.

19. The method of claim 18, wherein the polynomials are odd numbered polynomials.
